(19) United States
(12) Patent Application Publication
(10) Pub. No.: US 2012/0006440 A1
(43) Pub. Date: Jan. 12, 2012

(54) APPARATUS AND METHOD FOR LINING A PIPE JUNCTION

(75) Inventor: LARRY W. KIEST, JR., Ottawa, IL (US)

(73) Assignee: LMK ENTERPRISES, INC., Ottawa, IL (US)

(21) Appl. No.: 12/832,633

(22) Filed: Jul. 8, 2010

(51) Int. Cl. F16L 55/16

(52) U.S. Cl. 138/98

(57) ABSTRACT

A liner assembly is provided for repairing a pipe junction. The liner assembly includes a first and second camera and a containment bladder all operably connected to a launcher device, and which are used in combination by a user in a remote location to position and align the liner assembly in a main pipe, adjacent a lateral pipe, wherein no external access to the lateral pipe is available. The user will use images from the cameras to send control information to a positioning device, which positions and aligns a liner assembly with a lateral pipe. The liner assembly is then used to repair damage to the lateral pipe and the juncture between the main and lateral pipes.

### FIELD OF THE INVENTION

The present invention relates generally to sewer pipe line repair, and more particularly to an improved method and apparatus for repairing a lateral pipe of a sewer.

### BACKGROUND OF THE INVENTION

It is known in the art to install a main and lateral sewer pipe repair assembly from a main pipe. The assembly is moved through a main pipe until it reaches its destination, usually a position adjacent a lateral pipe. A lateral liner tube, which has been impregnated with a thermoset resinous material, is inverted from the assembly into the lateral pipe by inflating a lateral bladder tube. At the same time, a main bladder tube is inflated, which presses a main liner member against an area of the main pipe adjacent the lateral pipe opening to repair the juncture of the main and lateral pipe. Once the resin has cured, the bladders are removed from the lateral and main pipes, and the assembly is removed from the main pipe, while the cured main and lateral liners remain in the pipes. The liner members structurally repair the interior of the main and lateral pipes.

In the situation described above, it is important that the lateral liner tube is aligned with the lateral pipe prior to inversion of the liner tube. It is known in the art to position a camera in the lateral pipe with a viewing angle toward the main pipe to assist in aligning the lateral liner tube. However, in some instances it is not feasible to position a camera in the lateral pipe. It is also known to position a camera in the main pipe, but the viewing angles make it difficult to align the lateral liner tube with the lateral pipe.

Accordingly, there is a need in the art for an improved lining method and apparatus that overcomes the problems in remotely positioning a liner repair assembly in a main pipe adjacent a lateral pipe.

### BRIEF SUMMARY OF THE INVENTION

It is therefore a principal object, feature, or advantage of the present invention to provide an improved apparatus and method for repairing the juncture of a main sewer line with a lateral pipe.

Another object, feature, or advantage of the present invention is to provide an improved method and apparatus for remotely positioning a liner assembly in a main pipe.

Another object, feature, or advantage of the present invention is to provide an improved method and apparatus for remotely aligning a liner assembly with a lateral pipe.

These and/or other objects, features, and advantages of the present invention will be apparent to those skilled in the art. The present invention is not to be limited to or by these objects, features and advantages.

According to one aspect of the present invention, a liner assembly is provided. The liner assembly includes a launcher device, a main bladder tube, a lateral bladder tube, a containment bladder, a main liner member, and a lateral liner tube. The launcher device includes opposite first and second ends, an opening there between, and first and second cameras operably attached on opposite sides of and oriented towards the opening. The main bladder tube has opposite first and second ends, and a main bladder tube opening there between, and is outside and at least partially surrounds the launcher device. The lateral bladder tube extends from the main bladder tube opening and into the inside of the launcher device. The containment bladder at least partially surrounds the main bladder tube. The main liner member includes a main liner member opening, and at least partially surrounds the containment bladder. The lateral liner tube extends from the main liner member opening and through the main bladder tube opening and into the inside of the lateral bladder tube.

According to another aspect of the present invention, a method of lining a lateral pipe from a main pipe is provided. The method includes providing a liner assembly including a launcher device having first and second image devices operable attached thereto, a lateral bladder tube, and a lateral liner tube. The liner assembly is positioned in the main pipe. Image data is acquired from the first and second image device. The image data is used to assist in aligning the launcher device opening with the lateral pipe. The main liner member is pressed against the main pipe. The lateral liner tube is inserted into the lateral pipe, and the lateral liner tube is pressed against an interior wall of the lateral pipe.

According to another aspect of the present invention, a method of positioning a liner assembly in a main pipe connected to a lateral pipe is provided. The method includes providing a liner assembly including a launcher device having a first and second camera operable attached thereto, a main bladder tube, a lateral bladder tube, a main liner member, a lateral liner tube, and a positioning device operably connected to the launcher device. Images are displayed from the first and second camera on a display to assist a user in aligning the launcher device opening with the lateral pipe. Control information is received from the user. The position of the launcher device is moved based on the control information.

According to another aspect of the present invention, a method of positioning a liner assembly having a launcher device within a main pipe from which a lateral pipe extends is provided. The method includes providing a liner assembly including a launcher device having first and second image devices operable attached thereto, a main bladder tube, a lateral bladder tube, a main liner member, and a lateral liner tube. Image data is acquired from the first and second image device. The image data is used to assist in positioning the liner assembly within the main pipe.

According to yet another aspect of the present invention, a liner assembly is provided. The liner assembly includes a launcher device, a main bladder tube, a lateral bladder tube, a main liner member, and a lateral liner tube. The launcher device includes opposite first and second ends, an opening there between, and first and second cameras operably attached on opposite sides of and oriented towards the opening. The main bladder tube at least partially surrounds the launcher device. The lateral bladder tube is operably attached at the launcher device opening, and extends and averts into a cavity of the launcher device. The main liner member has a main liner member opening, and the main liner member at least partially surrounds the main bladder tube. The lateral liner tube extends from the main liner member about the main liner member opening and through the main bladder tube opening into the lateral bladder tube.

According to another aspect of the present invention, a liner assembly is provided. The liner assembly includes a launcher device having a first end, an opposite second end, and a launcher device opening there between. A first camera and a second camera are attached to the launcher device, with the first and second cameras being located on opposite sides of the launcher device opening and oriented towards the launcher device opening. A third camera is operably attached to the launcher device and is positioned so that the circumferential inner surface of the main sewer pipe is visible when the launcher device is positioned within the main pipe. A main bladder tube at least partially surrounds the launcher device. A lateral bladder tube extends through the launcher device opening and into the inside of the launcher device. A main liner member having a main liner member opening therein is position about the main bladder tube. A lateral liner tube extends from the main liner member about the main liner member opening, with the lateral liner tube extending through the main bladder tube opening and into the inside of the lateral bladder tube.

According to another aspect of the present invention, a method of positioning a liner assembly in a main pipe connected to a lateral pipe is provided. A liner assembly is provided. The liner assembly includes a launcher device having a first end and an opposite second end and a launcher device opening there between, a first and second camera operably attached to the launcher device and being located on opposite sides of the launcher device opening and oriented towards the launcher device opening, a third camera operably attached to the launcher device, the third camera positioned so that the circumferential inner surface of the main pipe is visible when the launcher device is positioned within the main pipe, a main bladder at least partially surrounding the launcher device, a lateral bladder tube, a main liner member having a main liner member opening therein and at least partially surrounding the main bladder, a lateral liner tube extending from the main liner member opening and a positioning device operably connected to the first end of the launcher device. The liner assembly is moved along the main pipe. Images are displayed from the third camera to assist a user in locating a lateral pipe connected to the main pipe. Images are displayed from the first and second cameras to assist a user in aligning the launcher device opening with the lateral pipe. Control information is received from the user. The position of the launcher device is moved based on the control information.

### BRIEF DESCRIPTION OF THE DRAWINGS

FIG. 1 is a perspective view of a launcher device having two image devices operably attached to assist in positioning a liner assembly.

FIG. 2 is a perspective view of the launcher device of FIG. 1, but with a positioning device attached as well.

FIG. 3 is a sectional view of one embodiment of the present invention at a juncture of a main pipe and a lateral pipe.

FIG. 4 is a view similar to FIG. 3, but showing the present invention in an inflated position in the pipe juncture.

FIG. 5A is a sectional view of the present invention showing the liner assembly moving through a main pipe.

FIG. 5B is a view similar to FIG. 5A, but with the launcher device adjacent a lateral pipe opening and with the launcher device opening not aligned with the lateral pipe opening.

FIG. 5C is a view similar to FIG. 5B, but after the liner assembly has been rotated to align a launcher device opening with a lateral pipe opening.

FIG. 6 is a sectional view of a second embodiment of the present invention at a juncture of a main pipe and a lateral pipe.

FIG. 7 is a view similar to FIG. 6, but showing the second embodiment in an inflated or expanded position in the pipe juncture.

FIG. 8 is a diagram showing image devices connected to a display, which is used to control the position and alignment of a launcher and positioning device in a pipe according to the present invention.

FIG. 9 is another embodiment of a positioning device used in combination with the launcher and liner assembly of the present invention.

FIG. 10A is a top planar view of another potential embodiment of the present invention using the positioning device of FIG. 9 connected to the launcher device with the positioning device connected to the launcher device.

FIG. 10B is a side view of the assembly of FIG. 10A showing the positioning device starting to disconnect from the launcher device.

FIG. 10C is a view similar to 10B after the positioning device has fully disconnected from the launcher.

FIG. 11 is a sectional view of another embodiment of the present invention at a juncture of a main and lateral pipe.

FIG. 12 is a view similar to FIG. 11 showing the lateral liner and bladder expanded into the lateral pipe.

FIG. 13 and FIG. 14 are sectional views of the present invention at a main and lateral pipe juncture using a steam hose.

FIG. 15 is a sectional view of another embodiment of the present invention at a juncture of a main and lateral pipe.

### DETAILED DESCRIPTION OF THE PREFERRED EMBODIMENTS

Referring to FIGS. 3-5, a liner assembly is generally designated by the numeral 10. The liner assembly 10 includes a launcher device 12 having mounted thereto a T-shaped or Y-shaped liner and bladder. The liner consists of a main liner member 20 and a lateral liner tube 22. In one embodiment, the main liner member 20 is a tube, but it may also be other shapes as well, such as a collar. The bladder consists of a main bladder tube 14, comprising a first end 40, a second end 42, a main bladder tube opening 44, and a lateral bladder tube 16. The liner assembly 10 may also consist of a containment bladder 18, as well as hydrophilic seals 26. In the particular configuration shown in FIGS. 3-5, the liner and bladder are T-shaped, but they can also be Y-shaped to accommodate the lateral pipeline that intersects with a main pipeline at an oblique angle.

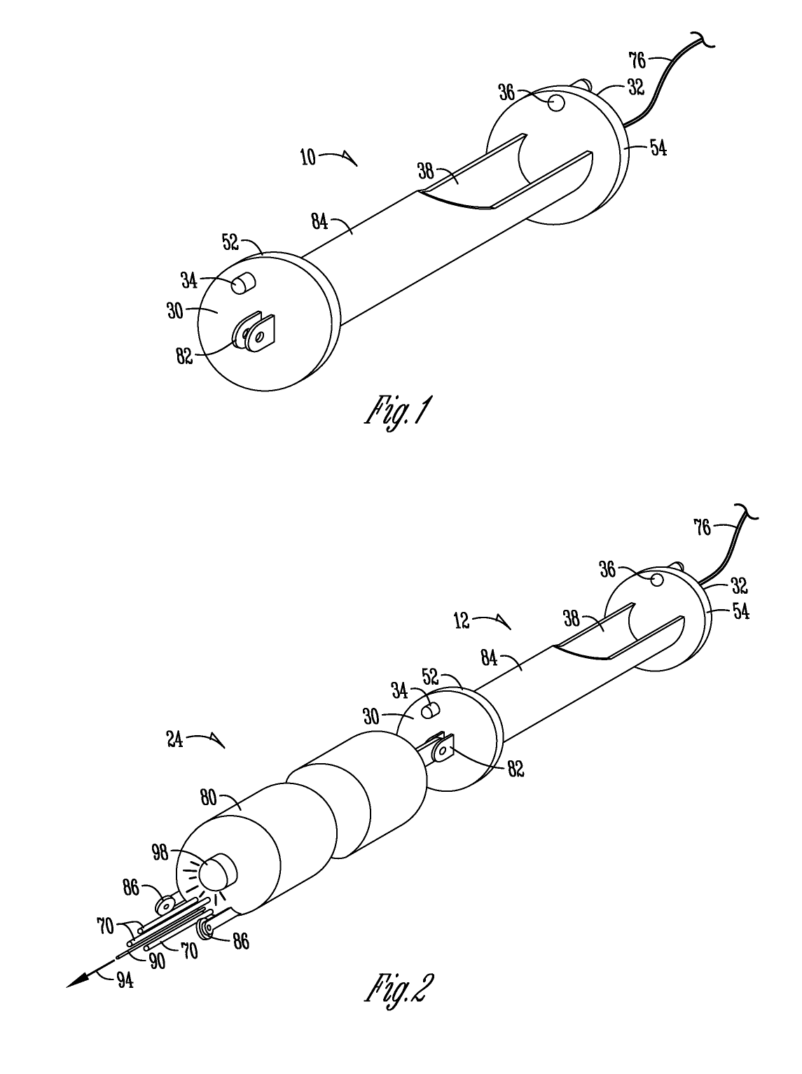

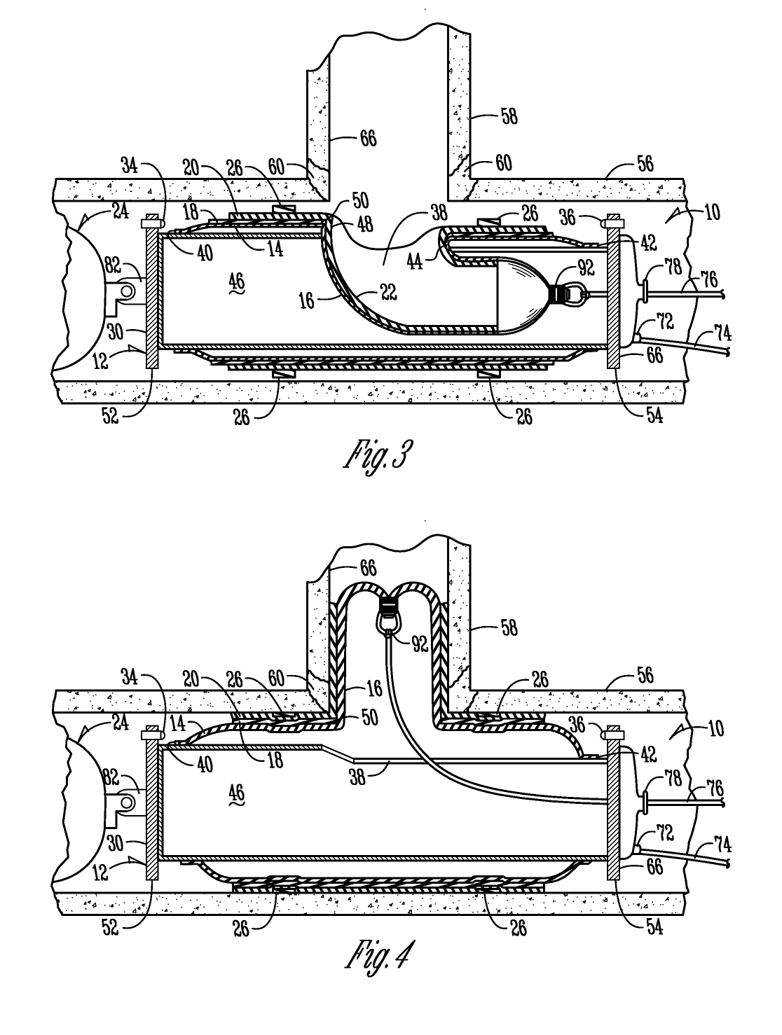

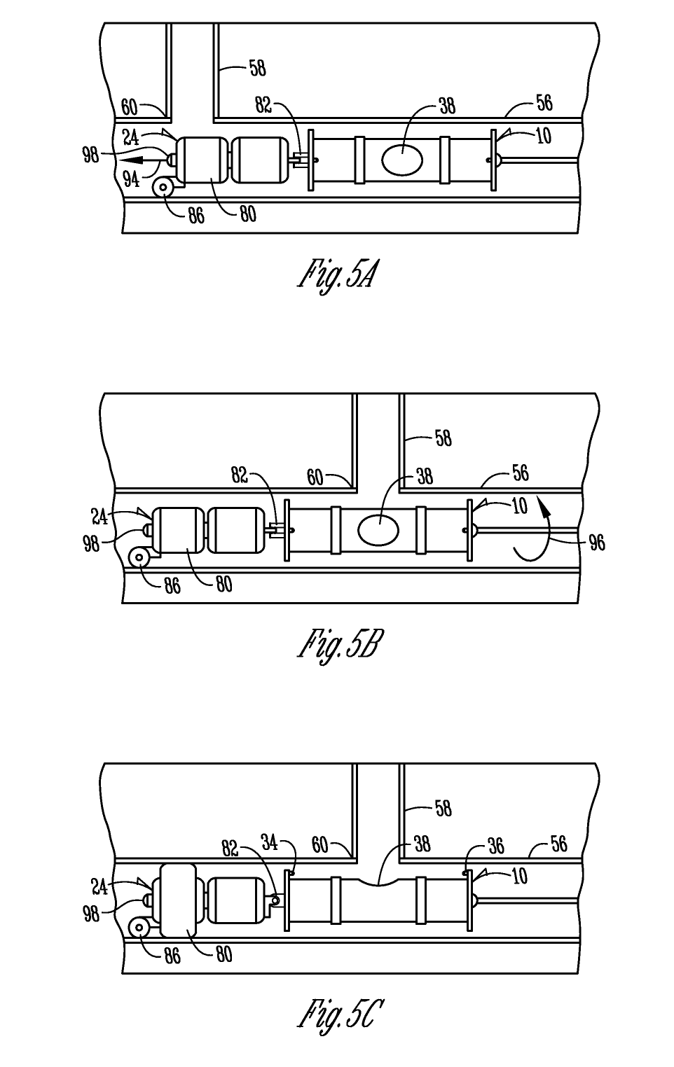

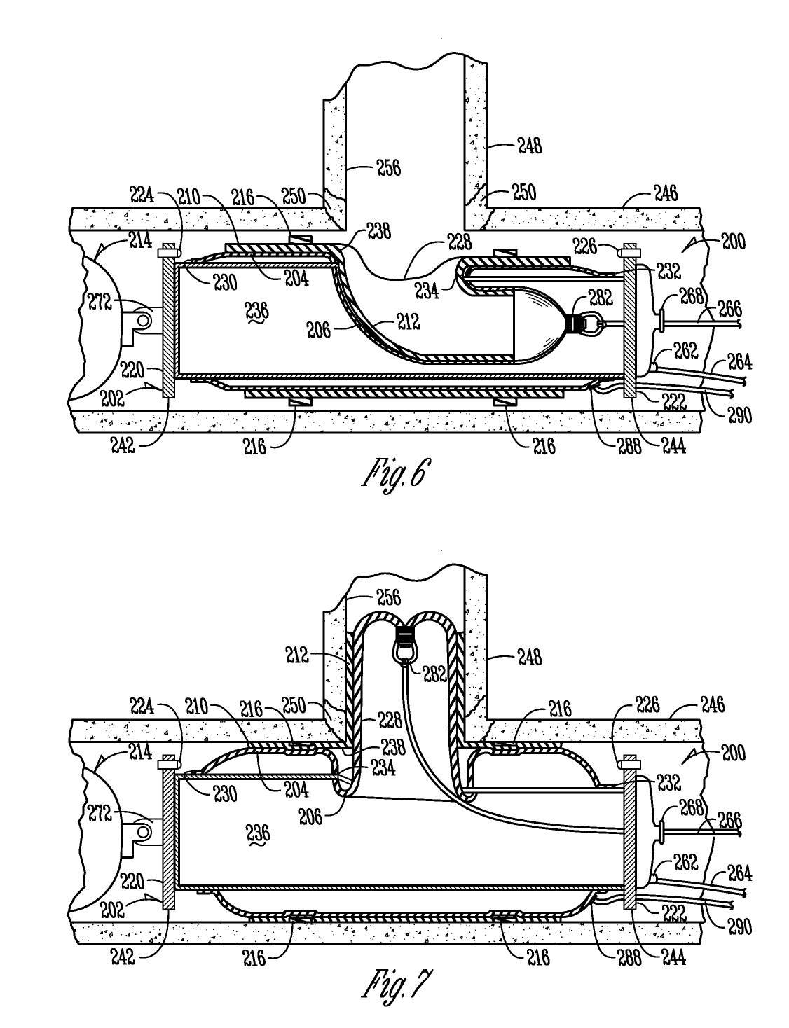

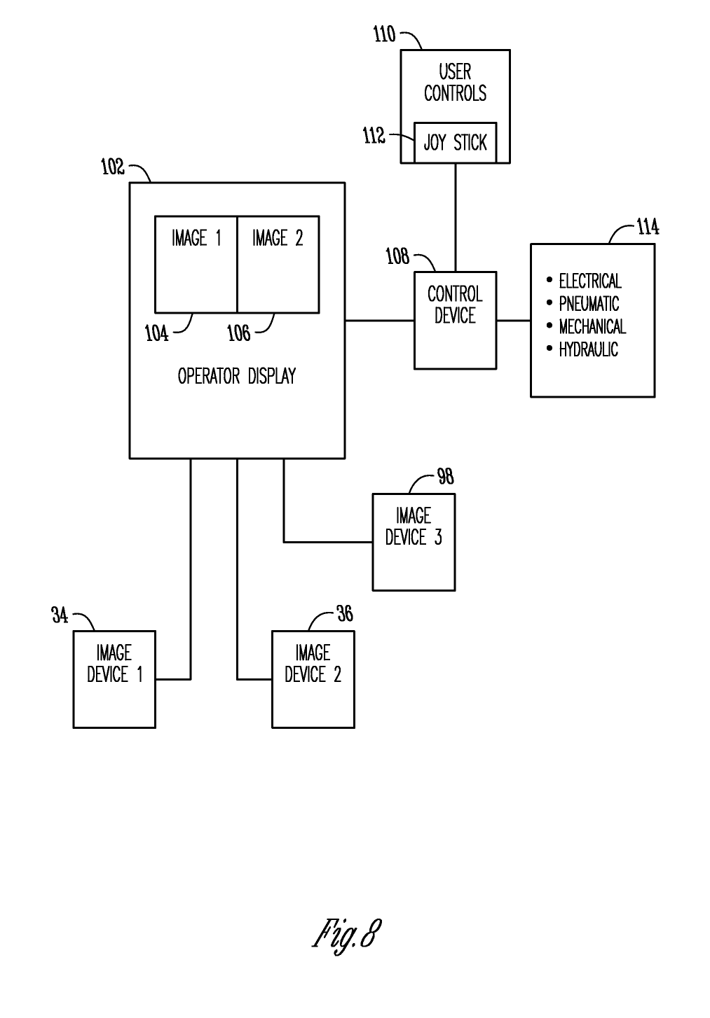

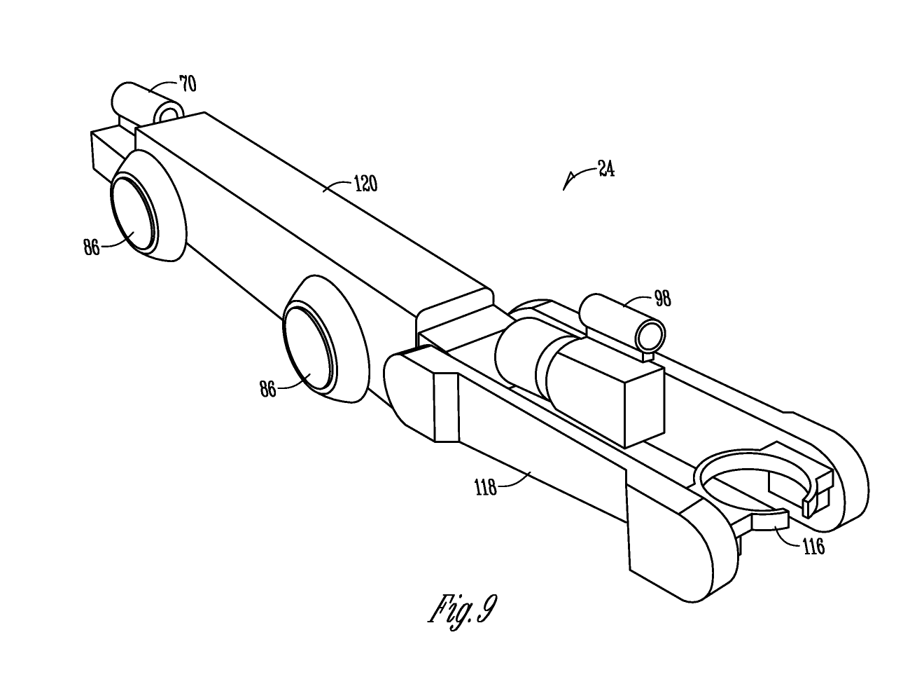

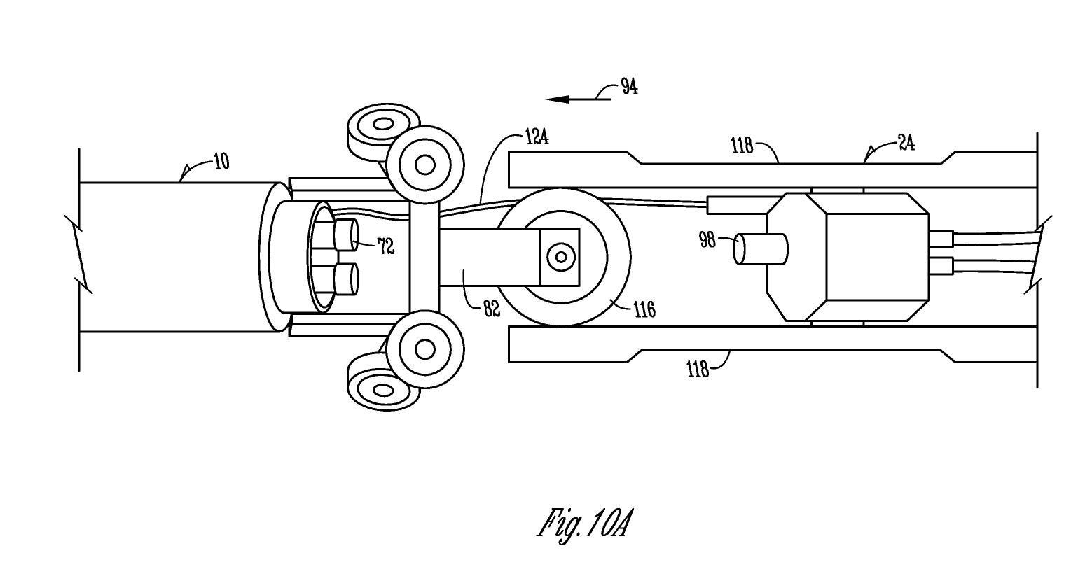

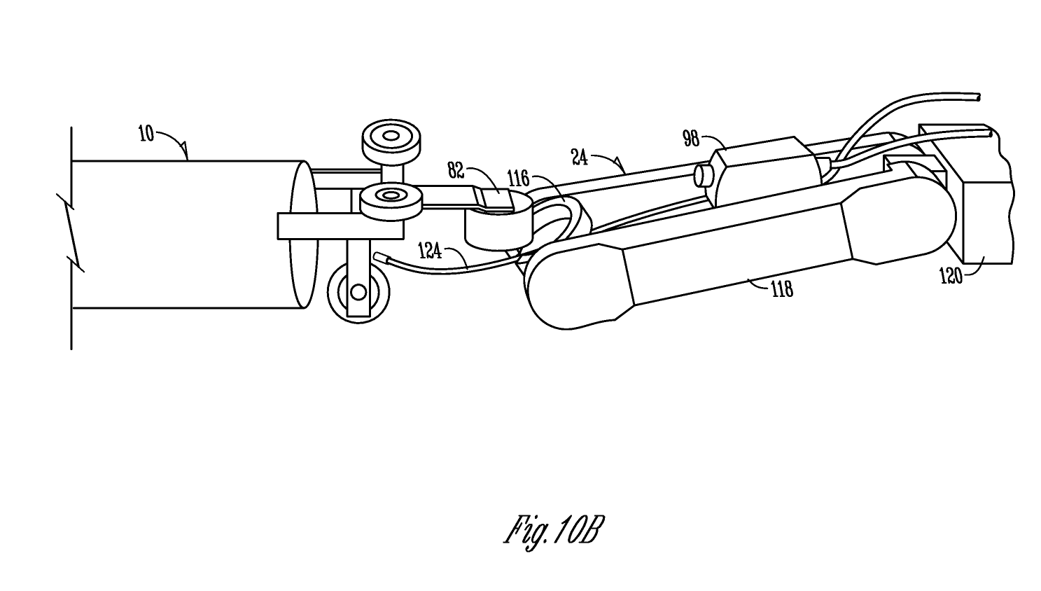

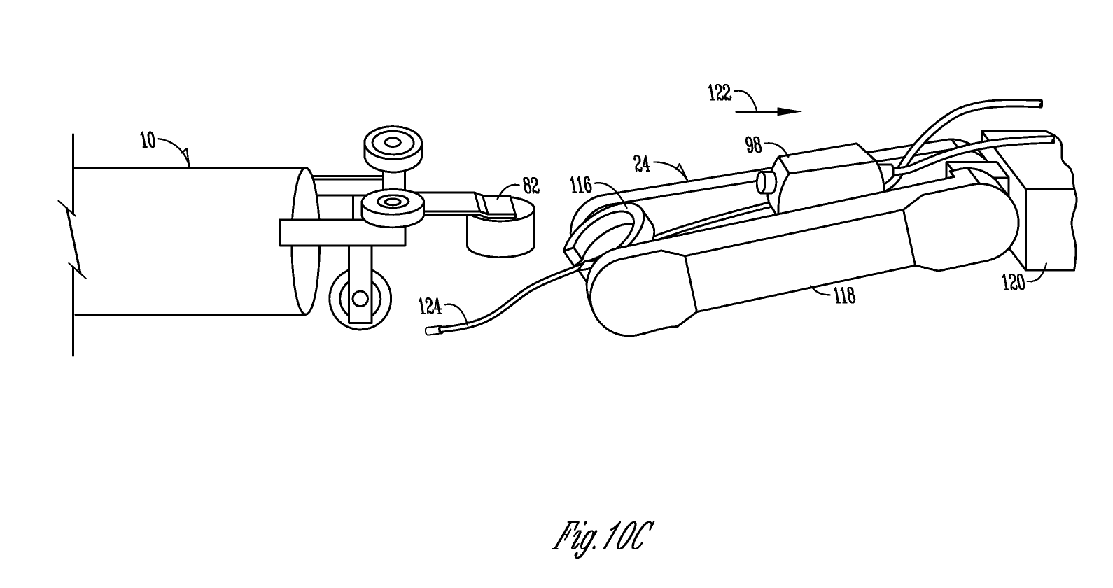

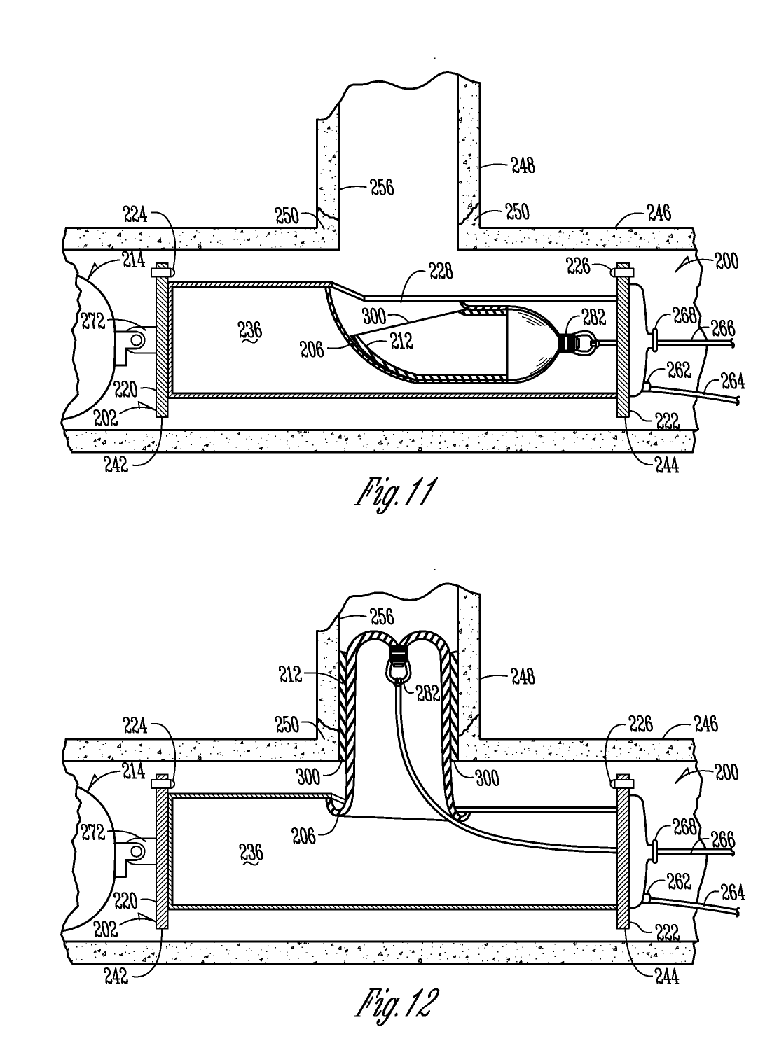

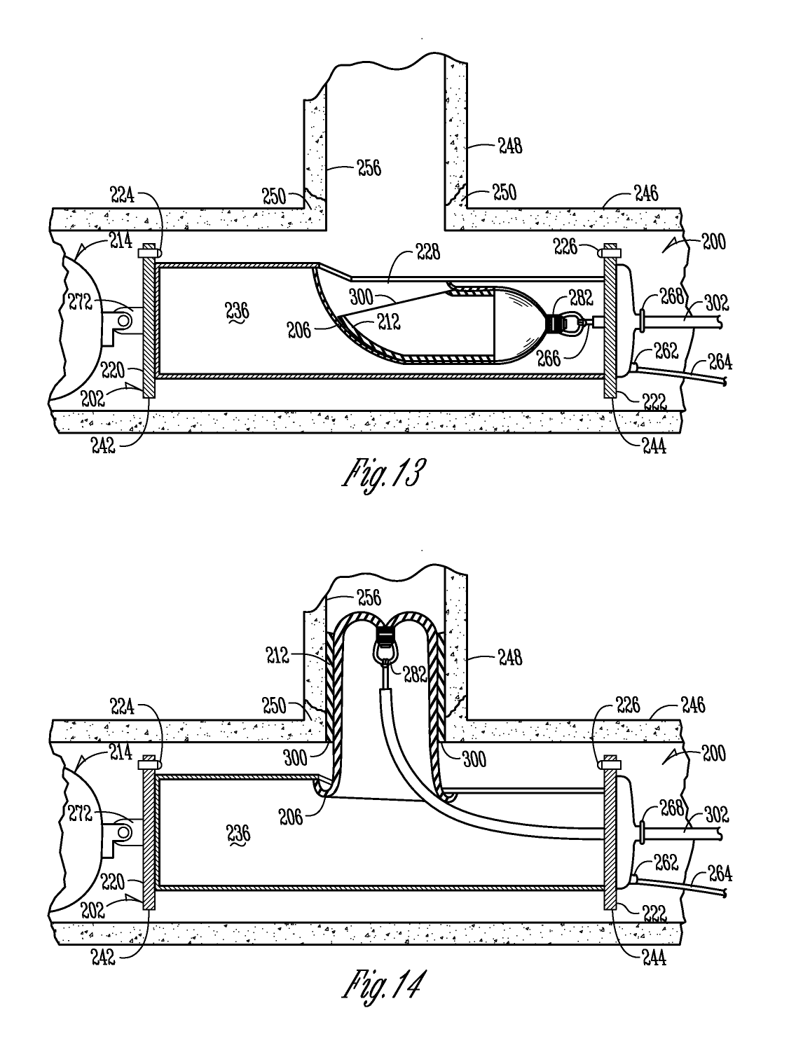

Now referring to FIG. 1, a launcher device 12 will be discussed in more detail. The launcher device 12 includes a first skid 52 on a first end 30 of the launcher device 12, and a second skid 54 on a second end 32 of the device. Protruding from the first skid 52 on the first end 30 of the launcher device 12 is a positioning device connector 82, which will assist in positioning the launcher device 12 within a pipe. Between the first end 30 and second end 32 of the launcher device 12 is a launcher side wall 84, and also a launcher device opening 38. Additionally, operably attached to the first skid 52 is a first camera 34, and operably attached to the second skid 54 is a second camera 36. The cameras are on opposite sides of the launcher device opening 38 and are oriented with viewing angles toward the same opening. While cameras may be preferred to use with the launcher device 12, it will be appreciated that additional image devices may be used as well. For example, a standard camera may display photographs and pictures, but it may be desirable to use an image device to capture other types of data, such as temperature, pressure, or the like.

FIG. 2 depicts the launcher device 12 attached to a positioning device 24. The positioning device 24 is attached to the launcher device 12 at the positioning device 24 connector 82 of the launcher device 12. The positioning device 24 is used to move the launcher device 12 through a main pipe and into a desired position in alignment with a lateral pipe. The positioning device 24 includes a positioning device plug 80, a set of hydraulic hookups 70, a pneumatic hookup 90, a positioning device line 88, and a positioning device wheel 86. The positioning device plug 80 may be used in operation with the pneumatic hookup 90 to expand and hold the positioning device 24 in place in a pipe. The set of hydraulic hookups 70 may be connected to a hose reel (not shown) with controls to extend and retract the positioning device 24 and rotate the head of the positioning device with the launcher device 12 in both clockwise and counterclockwise directions.

In addition to the first and second cameras 34, 36 described above, a third camera 98 can also be used to help position the launcher device 12 with the liner assembly 10. The purpose of this third camera 98 is to allow the operator to easily locate the opening to the lateral pipe as the positioning device 24 is moving the launcher device 12 along the main pipe. As shown in FIG. 2, the third camera 98 is positioned at the rearward end of the positioning device so that the interior circumference of the main pipe will be within the camera's field of view.

Now referring to FIG. 3, a sectional view of one embodiment of the present invention at a juncture 60 of a main pipe 56 and a lateral pipe 58 is shown. The liner assembly 10 is positioned in a main pipe 56 adjacent a lateral pipe 58. The liner assembly 10 preferably includes a launcher device 12, a main bladder tube 14, a lateral bladder tube 16, a containment bladder 18, a main liner member 20, a lateral liner tube 22, a positioning device 24, and hydrophilic seals 26. The launcher device 12 as described in FIG. 1 may be provided. The launcher device 12 has a first end 30, a second end 32 and a launcher device opening 38 therebetween. At the first end 30 of the launcher device 12 is a first skid 52, which has a camera 34 operably attached thereto, and at the second end 32 is a second skid 54, having a second camera 36 operably attached thereto. Positioned at least partially surrounding the launcher side wall 84 is a main bladder tube 14, which includes a first end 40, a second end 42 and a main bladder tube opening 44 therebetween. A lateral bladder tube 16 extends from the main bladder tube 14 at the main bladder tube opening 44 and may be inserted or averted inside the launcher device 12 to a launcher device cavity 46.

A tubular-shaped containment bladder 18 includes a containment bladder aperture 50 coinciding with the main bladder tube opening 44. The containment bladder 18 at least partially surrounds the main bladder member 44. The containment bladder 18 should fit snug around the main bladder member 44 so as to suppress the initial expansion of the main bladder member. The containment bladder can be made of an elastic material, such as TPU film, while it should be appreciated that other materials with similar characteristics may be used as well.

The main liner member 20 includes a main liner member opening 48 and also surrounds, at least partially, the containment bladder 18. The lateral liner tube 22 extends from the main liner member 20 about the main liner member opening 48 with the lateral liner tube 22 extending through the main bladder tube opening 44 and into the inside of the lateral bladder tube 16. In this embodiment, the lateral liner tube 22 is averted inside the lateral bladder tube 16. Hydrophilic seals 26 may be used with the liner assembly 10 to assist in restricting water seepage. The seals 26 are fully disclosed and described in U.S. Pat. No. 6,994,118, herein incorporated by reference in its entirety. Additionally, the liner assembly 10 includes a hook 92 attached to the lateral bladder tube 16. Attached to the hook is a line 76 extending through a line inlet 78. The liner assembly may also include an air inlet 72 and a coinciding air hose 74. It should be noted that the cameras 34, 36 are covered when the liners 20, 22 are attached to the launcher device 12 to prevent resin from smudging the camera lenses.

FIG. 4 is a sectional view similar to FIG. 3, but with the main bladder tube 14 and the lateral bladder tube 16 inflated. Air, or another fluid, is introduced in the cavity 46 of the launcher device 12 through hose 74, which in turn causes the bladders to expand. The lateral liner tube 22 and the lateral bladder tube 16 will invert through the launcher device opening 38 and into the lateral pipe 58, wherein the lateral liner tube 22 is pressed against the interior 66 of the lateral pipe 58. However, the lateral bladder tube 16 and lateral line tube 22 may need to be extended partially to aid in positioning the liner assembly 10 in the main pipe 56. In this embodiment, the first camera 34 and second camera 36 are used to position the liner assembly 10. So as not to interfere with the field of view of the first and second cameras 34, 36, the containment bladder 18 can be used to suppress the initial expansion of the main bladder tube 14. The containment bladder 18 causes the lateral bladder tube 16 and lateral liner tube 22 to expand at least partially before the main bladder tube 14, which allows a user to position the liner assembly 10 while keeping a clear view of the lateral opening in the main pipe 56. Eventually, the main bladder tube 14 will expand, pressing the main liner tube 20 and the hydrophilic seals 26 against the walls of the main pipe 56. Once the main bladder 14 and lateral bladders 16 have been fully expanded through the main pipe 56 and lateral pipe 58, the liner assembly is left in the pipe to allow for a resinous material, which has been impregnated into the lateral liner tube 22 and the main liner member 20, to cure and structurally renew the interior of the lateral pipe 58, main pipe 56, and pipe juncture 60. Once the thermoset resin has cured and hardened, the line 76 is used to remove the lateral bladder tube 16 from the lateral pipe 58 and back into the cavity 46 of the launcher device 12. The launcher device 12 and bladders may then be removed from the main pipe.

To account for a larger lateral liner tube 22 which may be needed with a longer lateral pipe 58, a lay-flat hose (not shown) may be attached to the second end 32 of the launcher device 12 to enlarge the cavity 46. The lateral liner tube 22 and the lateral bladder tube 16 may be extended into the lay-flat hose and then inverted through the hose and the launcher device 12 and into the lateral pipe 58 where the lateral liner tube 22 may be able to cure and harden, thus repairing the pipe.

FIGS. 5A-C depict a method of positioning the liner assembly 10 in a main pipe 56 using a positioning device 24. In FIG. 5A, the liner assembly 10 is shown moving through a main pipe 56. The liner assembly 10 is connected to a positioning device 24 at a positioning device connecting member 82. As shown in FIG. 5A, the positioning device and liner assembly 10 will move in a direction as depicted by the arrow 94 through a main pipe 56 towards a lateral pipe 58, which extends from the main pipe 56. The third camera 98 is used to locate the lateral pipe 58.

FIG. 5B shows the liner assembly 10 and the positioning device 24 at a position in the main pipe 56 wherein the liner assembly 10 is adjacent a lateral pipe 58. As shown in FIG. 5B, although the liner assembly 10 may be adjacent the lateral pipe 58, the launcher device opening 38 may not be aligned with the pipe. With the liner assembly 10 adjacent the lateral pipe 58, the positioning device plug 80 is inflated to press against the main pipe 56 to fix rearward portion of the positioning device relative to the main pipe 56. The forward portion of the positioning device 80 can then be extended, retracted and rotated as appropriate by the operator by inputting control information. The positioning device 24 will rotate the liner assembly 10 at the positioning device hookup 82 as depicted by the rotational arrow 96. The positioning device 24 may be controlled through hydraulic controls, electronic controls, pneumatic controls, or the like.

FIG. 5C shows the liner assembly 10 in an operable position with the launcher device opening 38 aligned with the lateral pipe 58. The first camera 34 and the second camera 36 are positioned to allow a user to view an area including a portion of the main pipe 56 and the lateral pipe 58, while being oriented towards the launcher device opening 38. FIG. 8 depicts a diagram of one type of image display system 100 that can be used with the present invention. It is preferable that the operator's display 102 include a split screen with images from both the first and second cameras 34, 36. The operator display shows a first image 104 from the first camera 34 and a second image 106 from the second camera 36. An additional image from the third camera 98 may also be viewed on the same display. While cameras are the preferred image device, it should be noted that other types of image devices are contemplated, such as sensors. In addition, the cameras 34, 36, 98 may be connected to the operator display 102 by wires, or they may be wirelessly connected.

An operator views the images 104, 106 to control the positioning device 24. A user control 110 is used to operate the positioning device 24. In FIG. 8, the user control 110 is shown to be a joystick 112. However, the invention contemplates various types of user controls, including but not limited to a mouse, a keyboard, a touch screen, a hand-held controller, a headphone with voice activation, or the like. It should be appreciated that other user controls are contemplated as well. The user controls work with a control device 108 to operate the positioning device 24. The control device 108 may be electrically, mechanically, pneumatically, or hydraulically driven. In addition, the control device 108 may be a combination of the aforementioned systems or another type of control altogether. Simultaneously viewing images from these cameras allows the operator to equalize between the images and accurately position the launcher device opening 38 with the lateral pipe 58. Once the liner assembly is in the desired position with the launcher device opening 38 aligned with the lateral pipe 58, the method of repairing the lateral pipe as described and shown in FIG. 4 may be undertaken.

FIGS. 6 and 7 show another embodiment utilizing separate main and lateral bladders. In FIG. 6 a liner assembly 200 is shown. The liner assembly 200 includes a launcher device 202. The launcher device 202 preferably includes a first end 220, a second end 222, a first skid 242 on the first end, a second skid 244 at the second end, a first camera 224 operably attached to the first skid 242, and a second camera 226 operably attached to the second skid 244. The first and second cameras are oriented towards a launcher device opening 228 located between the first end 220 and second end 222. The liner assembly 200 also includes a main bladder tube 204, which has a first end 230, a second end 232, and a main bladder tube aperture 234 therebetween. The main bladder tube 204 is positioned on the launcher device 202. The liner assembly 200 also includes a lateral bladder tube 206 attached at the launcher device opening 228, with the lateral bladder tube extending from and averting into a cavity 236 of the launcher device 202. The liner assembly 200 also includes a main liner member 210 having a main liner member opening 238 and at least partially surrounds the main bladder tube 204. Although the main liner member 210 may be shown as a tube, it should be appreciated that it may also be other shapes, such as a collar. The liner assembly 200 also includes a lateral liner tube 212 extending from the main liner member 210 about the main liner member opening 238. The lateral liner tube 212 extends through the main bladder tube aperture 234 and into the inside of the lateral bladder tube 206. Additionally, the liner assembly may include hydrophilic seals 216 surrounding the main liner member 210. A line 266 is connected to a hook 282 which in turn is connected to the lateral bladder tube 206 within the cavity 236 of the launcher device 202. A first air hose 264 is operably connected to a first air inlet 262 at the second end 222 of the launcher device 202. A second air hose 290 is operably connected to a second air inlet 288 at a second location on the launcher device 202.

FIG. 7 shows the liner assembly 200 of FIG. 6, after the main bladder tube 204 and the lateral bladder tube 206 have been inflated. The bladders may be inflated by air or another fluid having like characteristics. Preferably, air is first introduced in the cavity 236 of the launcher device 202 through the first air hose 264. The air causes the lateral bladder tube 206 and the lateral liner tube 212 to invert through the launcher device opening 228 and a short distance into the lateral pipe 248. This permits the operator to verify that the lateral liner tube 212 is properly aligned with the lateral pipe 248. The lateral bladder tube 206 and lateral liner tube 212 can then be reinverted into the launcher device cavity 236. Next, air is introduced through the second hose 290 and into the main bladder tube 204, which causes the main bladder 204 and the main liner member 210 to expand, pressing the main liner member 210 against the interior of the main pipe 246. The lateral liner tube 212 and lateral bladder tube 206 can then be fully inverted into the lateral pipe 248. The main liner member 210 and the lateral liner tube 212 are pressed against the main pipe 246 and the lateral pipe 248, respectively, until such time as the thermoset resin cures and hardens. Because the main bladder 204 and the lateral bladder 206 are not fluidly connected, an operator can expand the lateral bladder 206 without the main bladder 204 obstructing images taken by the first camera 224 and the second camera 226. Once the main liner 210 and the lateral liner 212 have cured and hardened, the lateral bladder tube 206 will be removed from the lateral pipe 248 by use of a line 266 connected to a hook 282, which is connected to the end of the lateral bladder tube 206. Air is released from the main bladder tube 204, which allows the liner assembly 200 to move through the main pipe 246 with the use of a positioning device 214 to a location where a user can remove the positioning device 214 from the main pipe 246.

FIG. 9 shows another embodiment of a positioning device 24 that can be used with the present invention. The positioning device 24 includes a body 120 and a set of positioning arms 118. Attached to the body 120 are a set of wheels 86. The positioning arms 118 are operably attached to the body 120 such that the arms may rotate, extend, or retract relative to the body. Attached to and between the positioning arms 118 is a launcher connector 116 for connecting the positioning device 24 to the launcher device 12 of the liner assembly 10. In this embodiment, the launcher connector 116 is adapted to receive a connector 82 of the launcher device 12, but other methods of connectivity are contemplated. While the launcher connector 116 is shown to be a circular aperture, is should be appreciated that other shapes and designs may be used. The launcher connector 116 is able to move relative the positioning arms 118. Also operably attached to the positioning device 24 is a third camera 98, which is able to rotate relative the device. The third camera 98 is oriented towards the launcher device 12 to aid in viewing the location of the assembly in a pipe. At the end of the positioning device 24 opposite the launcher connector 116 is a set of hookups 70, which are connected to controls for the device. An example of a positioning device 24 of this embodiment is Talpa FSR 2060 of Schwalm Robotic, but other models and manufacturers may be used.

FIGS. 10A-C display how the positioning device of FIG. 9 is connected to the liner assembly, and how it may be easily disconnected. FIG. 10A shows the positioning device 24 engagedly attached to the launcher device 12 of the liner assembly 10. As shown in FIG. 10B, the connector 82 of the launcher device 12 is a protrusion shaped similar to the aperture, so as to allow the connector 82 to be inserted into the aperture. In addition, an electrical cord 124 will be connected from the device to the launcher device 12 to supply power to the first and second cameras 34, 36 to align the launcher device opening 38 with a lateral pipe opening. Unlike the positioning device described in FIGS. 5A-C, which pulls the assembly, the positioning device 24 of FIGS. 10A-C pushes the liner assembly 10 through a pipe in the direction shown by the arrow 94. The third camera 98 relays images to an operator (not shown) to position the assembly in the pipe adjacent a lateral pipe opening. The camera 98 rotates about a horizontal axis to view the top and bottom of the pipe to find a lateral pipe opening. Once the positioning device 24 positions the liner assembly 10 adjacent a lateral pipe opening, the positioning arms 118 will rotate the liner assembly 10 as necessary to properly align the launcher device opening 38 and the lateral pipe opening.

As shown in FIG. 10B, once the liner assembly 10 is properly positioned, the positioning device 24 will disconnect from the launcher device 12. A quick disconnect is preferred so that the positioning device 24 can be connected to another liner assembly 10 to repair an additional lateral pipe while the first lateral pipe is also being repaired. This increases production and output. Because the arms 118 and launcher connector 116 can move relative one another, the disconnect can occur rather quickly. As shown in FIG. 10B, the ends of the arms 118 can be lowered to disengage the connector 82 of the launcher device 12 from the aperture of the launcher connector 116. The launcher connector 116 can then be rotated to further disengage it from the connector 82. Once disengaged, the assembly will look like the liner assembly 10 and the positioning device 24 of FIG. 10B.

After the connector 82 and the launcher connector 116 have disengaged, the positioning device 24 will move away from the launching device 12, as shown in FIG. 10C. The positioning device will move in the direction of the arrow 122 of FIG. 10C. The electrical cord 124 will be easily pulled from the launcher device 12 as well. The electrical cord 124 is attached to the launcher device 12 in much the same way that a household electrical cord is attached to an outlet in a wall. It should be noted that it does not take much force to detach the electrical cord from a wall. In much the same way, it does not take much force to remove the electrical cord 124 of the present invention from the launcher device 12. The positioning device 24 is then free from any attachment to the liner assembly 10, and can be moved through a pipe to be connected to another liner assembly, which improves productivity. However, the liner assembly 10 is still connected to an air hose 74. Therefore, the liner assembly 10 will be inflated as normal to repair the main and lateral pipes 56, 58, including the juncture 60 between the two. The method of inflation and repair is the way described either in FIGS. 3 and 4, or FIGS. 6 and 7.

Once the pipe has been repaired, and the resin has cured, the positioning device 24 can reconnect with the launcher device 12 to move the assembly to a location, such as a manhole, where it can be removed from the pipe. The positioning device 24 can reconnect to the launcher device 12 is the same, but opposite way that it disconnected. The arms 118 will lower the launcher connector 116 to below the connector 82 of the launching device 12. The launcher connector 116 will rotate to align its aperture with the connector 82, and then the arms 118 will be raised to engage the two connectors 82, 116. The electrical cord will not have to be reattached to the launcher device 12 because it powers the first and second cameras 34, 36, and they are not needed for removal, as the third camera 98 can be used to relay images of the pipe to an operator to aid in moving to a location for removal.

FIG. 11 illustrates another embodiment of the present invention at a juncture of a main and lateral pipe. Note that in FIG. 11, no main bladder is needed; only the lateral bladder 206 is needed. Thus, inversion can occur up a lateral pipe 248. A launcher device 202, such as described above in FIGS. 6 and 7, can be used in this embodiment. Dual cameras 224, 226 may still be used to assist in positioning with the positioning device 214 and launcher device 202 within the pipes. In addition, the lateral liner 212 may be frangibly attached to the lateral bladder 206. The lateral liner 212 can be attached to the lateral bladder 206 at a tab or connection area 300. The connection may be done in a variety of ways, with the key being that the lateral liner 212 and the lateral bladder 206 are frangibly connected to be able to be separated with some ease. Therefore, the liner and bladder may be attached to one another by a releasable adhesive, tape, stitches or other methods that will keep the two together, but will allow them to be separated from one another without damaging either. Note that the tab area 300 may be below the edge of the launching device 202 so that the liner 212 will start lining the lateral pipe 248 at the juncture 250 of the main and lateral pipes. This is important when there is no main bladder used so that it will not be necessary to come back and cut part of the liner from the main pipe. It is further necessary in this embodiment to sealably attach the lateral bladder 206 to the launcher device 202 at the launcher device opening 228. The bladder must be attached such that air, steam, or another fluid can expand the lateral bladder 206 without leaking into the surrounding pipes.

FIG. 12 illustrates the embodiment of FIG. 11 after the lateral bladder 206 has been expanded into the lateral pipe 248. As shown in FIG. 12, the lateral bladder 206 and lateral liner 212 will be inverted as air, steam, or some other fluid expands them. The fluid is introduced through the air inlet 262 via an air hose 264. The fluid causes the lateral bladder 206 to invert into the lateral bladder 248. Because the lateral liner 212 is frangibly connected to the lateral bladder 206, the liner and bladder will invert together into the pipe 248. The liner 212 has been positioned within the bladder 206 such that the liner will begin lining the lateral pipe 248 at the juncture 250 of the main and lateral pipes. A line 266 run through a line inlet 268 is connected to an expanding end of the bladder at a hook 282. After the liner 212, which has been impregnated with a resinous material, has cured and hardened, the line 266 is used to peel the bladder 206 away from the liner. The method of frangibly connecting the bladder and liner will dictate the amount of force needed to separate the two at the tab area 300.

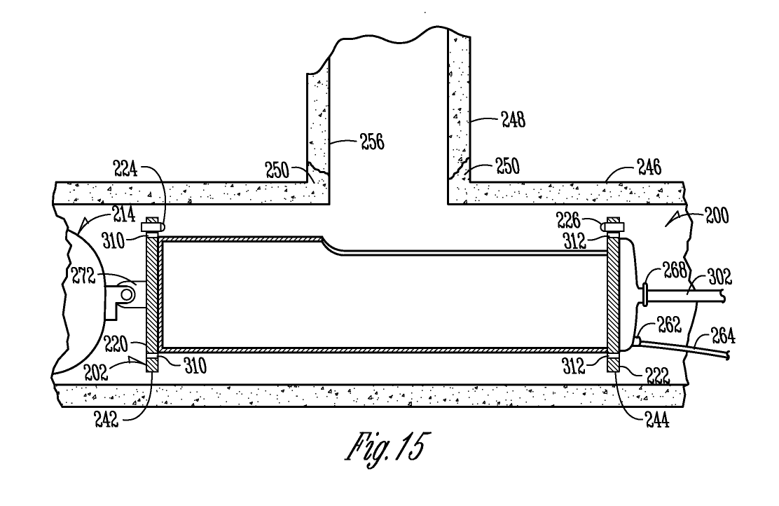

FIG. 13 and FIG. 14 illustrate an embodiment of the launcher device 202 with an internal steam hose 302. This embodiment is particularly useful where steam from the bladder cannot be exhausted through a cleanout during the curing process. A steam hose 302 is inserted through an end of the launcher device 202. The hose 302 is attached adjacent the hook 282 at the expanding end of the lateral bladder 206. The steam hose 302 runs through the inlet 268 in one side of the launching device 202. As the liner and bladder are expanded and inverted, the steam hose 302 is also drawn up into the lateral pipe 248. Each end of the hose is open ended. Steam may be used to expand the bladder to press the lateral liner 212 against the interior of the lateral pipe 248. Steam may be preferred when using a resin which cures faster when introduced to heat. The steam will reduce the cure time, which could increase production and efficiency. However, as new steam is added to the bladder, there is only so much room in the bladder and the steam must continually be exhausted or recycled from the bladder. When there is no access to a cleanout, the use of the steam hose 302 will remove the steam from the interior of the pipe. As the steam is introduced to the interior 236 of the launching device via the hose 264 and inlet 262, the bladder 206 will expand. Steam will enter a first end of the hose near the hook 282 at the expanding end of the bladder. The steam will go back through the hose and be discharged into the main pipe. A pump or vacuum system (not shown) may be included with the steam hose 302 to aid the removal of the steam from the lateral pipe as well. The length of the hose 302 will depend on the length of the lateral pipe 248 being lined and repaired. It is preferred that one end of the hose be near the expanding end of the lateral bladder, and the other end be outside the launching device in the main pipe. While the steam hose 302 is shown to be used with the embodiment shown in FIGS. 11 and 12, it should be appreciated that it can be incorporated with any of the embodiments, including those shown and described in FIGS. 3, 4, 6, and 7. The key is that the hose 302 must seal the opening in the inlet 78,268 to ensure that the steam is routed outside the bladder and launcher device 12,202 and into the main pipe when there is no access to a cleanout. It should further be appreciated that the steam hose 302 can be used with a lay flat hose (not shown) when the length of pipe that needs repaired exceeds the amount of pipe that fits within the launcher device alone.

FIG. 15 illustrates another embodiment of the present invention where pin holes 310, 312 are placed on skids 242, 244 of a launcher 202. These are holes 310, 312 in the skids 242, 244 that receive pins (not shown) that pass through the wall of the bladder so as to act as a template or fixture that positions the bladder on the launcher 202 the same way every time so to eliminate any twisting of the bladder during the banding procedure. Once banded, the pins are removed. The cameras 224, 226 may be used to assist in alignment. The number of pins may vary. One embodiment may have a plurality of holes spaced radially about the skids 242, 244, while another may have one pin hole on each skid to aid in positioning the bladder on the launching device.

The invention has been shown and described above with reference to the preferred embodiments, and it is understood that many modifications, substitutions, and additions may be made which are within the intended spirit and scope of the invention. The invention is only to be limited by claims appended hereto.

What is claimed is:

1. A liner assembly, comprising:
a launcher device having a first end, an opposite second end, a launcher device opening there between, and a first and a second camera operably attached thereto, the first and second cameras being located on opposite sides of the launcher device opening and oriented towards the launcher device opening;
a main bladder tube having a first end, an opposite second end, and a main bladder tube opening there between;
a lateral bladder tube extending from the main bladder tube about the main bladder tube opening;
the main bladder tube being outside and surrounding the launcher device and the lateral bladder tube extending through the launcher device opening and into the inside of the launcher device;
a containment bladder at least partially surrounding the main bladder tube;
a main liner member having a main liner member opening therein, the main liner member at least partially surrounding the containment bladder; and
a lateral liner tube extending from the main liner member about the main liner member opening, the lateral liner tube extending through the main bladder tube opening and into the inside of the lateral bladder tube.

2. The liner assembly of claim 1 wherein the containment bladder is tubular shaped.

3. The liner assembly of claim 2 wherein the containment bladder includes an aperture surrounding the launcher device opening.

4. The liner assembly of claim 3 wherein the containment bladder is comprised of an elastic material.

5. The liner assembly of claim 1 wherein the containment bladder is adapted to suppress the main bladder tube.

6. The liner assembly of claim 1 wherein the main liner member is a tube.

7. The liner assembly of claim 1 further comprising a positioning device operably connected to the first end of the launcher device and adapted to position the liner assembly in a main pipe to a position adjacent a lateral pipe opening.

8. The liner assembly of claim 1 further comprising hydrophilic seals disposed at least partially around the main liner member.

9. The liner assembly of claim 1 wherein the main liner member and the lateral liner tube are comprised of a resin absorbent material.

10. The liner assembly of claim 9 wherein a resinous material capable of curing and hardening is applied to the lateral liner tube and the main liner member.

11. The liner assembly of claim 1 further comprising a lay flat hose operably attached to the second end of the launcher device, the lay flat hose adapted to receive extended portions of lateral bladder tube and lateral liner tube.

12. The liner assembly of claim 1 wherein the launcher device further comprises a first skid on the first end of the launcher device, and a second skid on the second end of the launcher device.

13. The liner assembly of claim 12 wherein the first camera is operably connected to the first skid, and the second camera is operable connected to the second skid on the launcher device.

14. The liner assembly of claim 12 wherein the first skid and the second skid each have one or more holes for accepting pins that pass through the main bladder tube for positioning the main bladder tube relative to the launcher device.

15. A method of lining a lateral pipe from a main pipe, comprising:
providing a liner assembly including a launcher device having a launcher device opening therein and a first and second image device operably attached thereto, a lateral bladder tube, and a lateral liner tube;
positioning the liner assembly in the main pipe;
acquiring image data from the first and second image devices;
using the image data to assist in aligning the launcher device opening with the lateral pipe;
inserting the lateral liner tube into the lateral pipe; and
pressing the lateral liner tube against an interior wall of the lateral pipe.

16. The method of claim 15 wherein the lateral tube is inverted into the lateral pipe.

17. The method of claim 15 further comprising impregnating the lateral liner tube with a resinous material capable of curing and hardening.

18. The method of claim 15 further comprising providing a positioning device operably connected to the launching device.

19. The method of claim 18 wherein the liner assembly is moved through the main pipe by the positioning device.

20. The method of claim 19 wherein the launcher device is positioned by the positioning device.

21. The method of claim 19 wherein the launcher device further comprises a first skid on the first end of the launcher device, and a second skid on the second end of the launcher device.

22. The method of claim 21 wherein the first image device is operably connected to the first skid, and the second image device is operably connected to the second skid on the launcher device.

23. The method of claim 15 wherein the lateral liner tube is frangibly connected to the lateral bladder tube at a tab area.

24. The method of claim 23 wherein glue is used to frangibly connect the lateral liner tube to the lateral bladder tube at the tab area.

25. The method of claim 15 further comprising using a steam hose passing through the launcher device to cause steam to exit out through the steam hose and into the main pipe.

26. The method of claim 15 further comprising inflating the lateral bladder tube.

27. The method of claim 26 wherein the lateral liner is pressed against the pipe walls by the inflated lateral bladder tube.

28. A lateral pipe lined by the method of claim 15.

29. A method of positioning a liner assembly in a main pipe connected to a lateral pipe, comprising:
providing a liner assembly including a launcher device having a first end and an opposite second end, a launcher device opening there between, and a first and second camera operably attached thereto, a main bladder at least partially surrounding the launcher device, a lateral bladder tube, a main liner member having a main liner member opening therein and at least partially surrounding the main bladder, a lateral liner tube extending from the main liner member opening and a positioning device operably connected to the first end of the launcher device;
displaying images from the first and second cameras on a display to assist a user in aligning the launcher device opening with the lateral pipe;
receiving control information from the user; and
moving the position of the launcher device based on the control information.

30. The method of claim 29 further comprising inflating a plug operably connected to the positioning device to lock the liner assembly in place in the main pipe.

31. The method of claim 29 wherein the positioning device is extended and retracted.

32. The method of claim 31 wherein the positioning device is rotated.

33. The method of claim 29 wherein the positioning device is controlled from a position outside the main pipe.

34. The method of claim 33 wherein the images from the first and second cameras are viewed from a position outside of the main pipe.

35. The method of claim 29 further comprising expanding the main bladder tube and the lateral bladder tube enough to view, with the first and second cameras, a portion of the lateral liner tube extending outwardly from the main liner member opening to assist in aligning the launcher device opening with the lateral pipe.

36. The method of claim 35 wherein the images from the first and second cameras are simultaneously displayed on the display.

37. A method of positioning a liner assembly having a launcher device within a main pipe from which a lateral pipe extends, the method comprising:
providing a liner assembly including a launcher device having a launcher device opening therein and a first and second image device operably attached thereto, a main bladder at least partially surrounding the launching device, a lateral bladder tube, a main liner member having a main liner member opening therein and at least partially surrounding the main bladder, and a lateral liner tube extending from the main liner member opening;
acquiring image data from the first and second image device; and
using the image data to assist in positioning the liner assembly within the main pipe.

38. The method of claim 37 wherein the step of using the image data to assist in positioning the launcher device within the main pipe comprises displaying a representation of the image data to a user and receiving control information from the user.

39. The method of claim 38 further comprising positioning the launcher device using a positioning device.

40. A liner assembly comprising:
a launcher device having a first end, an opposite second end, a launcher device opening there between, and a first and a second camera operably attached thereto, the first and second cameras being located on opposite sides of the launcher device opening and oriented towards the launcher device opening;
a main bladder tube being outside and at least partially surrounding the launcher device;
a lateral bladder tube operably attached at the launcher device, the lateral bladder tube extending and averted into a cavity of the launcher device;
a main liner member having a main liner member opening therein, the main liner member at least partially surrounding the main bladder tube; and
a lateral liner tube extending from the main liner member about the main liner member opening, the lateral liner tube extending through the main bladder tube aperture and into the inside of the lateral bladder tube.

41. The liner assembly of claim 40 further comprising a containment bladder at least partially surrounding the main bladder tube;

42. The liner assembly of claim 41 wherein the main liner member at least partially surrounds the containment bladder.

43. The liner assembly of claim 42 wherein the containment bladder includes an aperture surrounding the launcher device opening.

44. The liner assembly of claim 43 wherein the containment bladder is comprised of an elastic material.

45. The liner assembly of claim 40 further comprising hydrophilic seals disposed at least partially around the main liner member.

46. The liner assembly of claim 40 wherein the main liner member and the lateral liner tube are comprised of a resin absorbent material.

47. The liner assembly of claim 46 wherein a resinous material capable of curing and hardening is applied to the lateral liner tube and the main liner member.

48. The liner assembly of claim 40 wherein the main bladder and the lateral bladder tube are not fluidly connected.

49. The liner assembly of claim 40 further comprising a steam hose passing through the launcher device to cause steam to exit out through the steam hose.

50. A liner assembly comprising:
a launcher device having a first end, an opposite second end, a launcher device opening there between;
a first camera and a second camera operably attached to the launcher device, the first and second cameras being located on opposite sides of the launcher device opening and oriented towards the launcher device opening;
a third camera operably attached to the launcher device, the third camera positioned so that the circumferential inner surface of the main sewer pipe is visible when the launcher device is positioned within the main pipe;
a main bladder being outside and surrounding the launcher device;
a lateral bladder tube extending through the launcher device opening and into the inside of the launcher device;
a main liner member having a main liner member opening therein; and
a lateral liner tube extending from the main liner member about the main liner member opening, the lateral liner tube extending through the main bladder tube opening and into the inside of the lateral bladder tube.

51. The liner assembly of claim 50 further comprising a steam hose passing through the launcher device to cause steam to exit out through the steam hose.

52. A method of positioning a liner assembly in a main pipe connected to a lateral pipe, comprising:
providing a liner assembly including a launcher device having a first end and an opposite second end and a launcher device opening there between, a first and second camera operably attached to the launcher device and being located on opposite sides of the launcher device opening and oriented towards the launcher device opening, a third camera operably attached to the launcher device, the third camera positioned so that the circumferential inner surface of the main pipe is visible when the launcher device is positioned within the main pipe, a main bladder at least partially surrounding the launcher device, a lateral bladder tube, a main liner member having a main liner member opening therein and at least partially surrounding the main bladder, a lateral liner tube extending from the main liner member opening and a positioning device operably connected to the first end of the launcher device;
moving the liner assembly along the main pipe;
displaying images from the third camera on a display to assist a user in locating a lateral pipe connected to the main pipe;
displaying images from the first and second cameras on a display to assist a user in aligning the launcher device opening with the lateral pipe;
receiving control information from the user; and
moving the position of the launcher device based on the control information.
